(19) United States
(12) Patent Application Publication
(10) Pub. No.: US 2022/0261789 A1
(43) Pub. Date: Aug. 18, 2022

(54) PERSONAL IDENTIFIABLE INFORMATION VERIFICATION FOR DECENTRALIZED NETWORK SERVICES

(71) Applicant: NCR Corporation, Atlanta, GA (US)

(72) Inventor: Bryan Walser Nonni, Atlanta, GA (US)

(21) Appl. No.: 17/733,183

(22) Filed: Apr. 29, 2022

Related U.S. Application Data
(63) Continuation-in-part of application No. 17/162,663, filed on Jan. 29, 2021.
Application No. 17/162,663 is a continuation-in-part of application No. 17/725,682, filed on Apr. 21, 2022.

(51) Int. Cl. G06Q 20/36; G06Q 20/06; G06F 21/62

(52) U.S. Cl. CPC G06Q 20/363; G06Q 20/065; G06Q 2220/00; G06F 21/6245; G06Q 20/367

(57) ABSTRACT

Centralized Financial (CeFi) services of a Financial Institution (FI) application (app) is enhanced such that the customer can access Decentralized Financial (DeFi) services via the app utilizing a cloud service. The customer preregistered Personal Identification Information (PII) with a Self-Sovereign Identity (SII) provider. When a customer attempts to access a DeFi service, the cloud service intervenes and establishes a Decentralized Identity (DID) based connection between a wallet of the customer and a wallet of the FI through the provider. The FI challenges the identity of the customer and requests that a portion of the PII be shared for Know Your Customer (KYC) requirements, the customer shares, and the SII provides a certification and the portion of the PII back to the FI. The FI stores the certification in a customer record as evidence that KYC requirements were satisfied before the customer accesses the DeFi service from the FI's app.

### RELATED APPLICATIONS

This application is a Continuation-In Part (CIP) of application Ser. No. 17/162,663 entitled “Self-Sovereign Identity Verifiable Credentials for Consent Processing” filed on Jan. 29, 2021; further, this application is a CIP of application Ser. No. 17/725,682 entitled “Decentralized Network Services for Centralized Network Services” filed Apr. 21, 2022; the disclosures of which are hereby incorporated by their entireties herein

### BACKGROUND

Enterprises and governments rely heavily and collecting data from their customers and citizens. In fact, private and public information about every individual is almost certainly maintained by a plethora of different entities in a variety of data warehouse located across the globe. This has caused a great deal of problems for individuals and for the enterprises. Individuals' personal and private data are routinely stolen and used for nefarious purposes with the unwittingly assistance of government bureaucrats and government systems to obtain false government identification cards or government benefits. Consumers are frequently targeted and harassed by businesses based on their spending habits, browser history, and location data.

In the midst of this chaos, governments are finally realizing that data about an individual should belong to the individual and not collected and used by businesses, governments, or organizations. Some countries have adopted more stringent laws and regulations should a consumer be harmed by a data breach at an enterprise that houses some of the consumer's data. Some countries have adopted laws that make clear any retention of consumer data needs to have the express informed consent of the consumer and/or requires payment of a fee to the consumer.

Yet governments are also concerned about fraud, terrorist-related activities, and identity theft. As a result, Financial Institutions (FIs) have to adhere to strict regulations about onboarding their customers and offering services to their customers. These regulations are referred to as “Know Your Customer’ (KYC) requirements. KYC requirements ensure that a FI gets and verifies Personal Identifiable Information (PII) for each of their customers during onboarding and when any service is requested by the customer of the FI. Thus, privacy is a known problem that governments are struggling to deal with while at the same time governments are unsure as to how to improve privacy rights while still requiring the FIs properly maintain KYC requirements for their customers.

Additionally, the world of Decentralized Finance (DeFi) is exploding with new technologies and products offering the most competitive Returns on Investments (ROIs) to consumers in 40 years. Consumers can now get yield rates in the double digits by leveraging DeFi protocols such as Maker®, AAve®, Compound®, Alchemix®, or Yearn.fi® to name only a few. These protocols offer these high yields on various cryptocurrencies that can be volatile; however, almost all offer similar yields on United Stated Dollar (USD)-pegged stabled coins. Consumers can hedge volatility risk and simultaneously earn 10%+ on their dollar.

As a result, consumers are discovering these options and moving away from traditional Centralized Finance (CeFi). In fact, Financial Institutions (FIs) are missing out on a large debt and finance market available through the Blockchain (BC) and cryptocurrency environments. DeFi technology is rapidly emerging and providing very attractive financial products with high Annualized Percent Yields (APY) for consumers on their cryptocurrencies and stable coins. DeFi investments have reach an all-time high at $105 billion dollars invested into the BC and cryptocurrency ecosystem via smart contracts on various Ethereum®-based BCs. A year or so ago, in October of 2020, this investment total was just $21 billion dollars. For comparison, in the third quarter (Q3) of 2020, the total U.S. credit card debt was $807 billion dollars. The DeFi ecosystem is now ⅛^{th} of the total U.S. credit card debt. The implication is that this market will continue to grow and as it does, it will continue to exclude CeFi FI who will be losing millions to billions of dollars in lost debt serving, loan servicing, and investment servicing.

In many cases CeFi FIs are excluded from participating in DeFi arrangements due to government regulations (which prohibit direct cryptocurrency involvement by the FIs) and their own risk tolerances. Even if this is solved such that the FI risk tolerances are mitigated, the FIs still have to strictly adhere to KYC requirements for the customers that may be participating in DeFi-based products through their FI.

### SUMMARY

In various embodiments, methods and a system for Personal Identifiable Information (PII) verification for decentralized network services are presented.

According to an embodiment, a method for PII verification for decentralized network services. An attempt to connect to a decentralized network service is detected from an application that provides centralized network services. A decentralized identifier (DID) connection between a customer wallet of a customer and a financial institution (FI) wallet of a FI is that provides the application to the customer is facilitated using a Self-Sovereign Identity (SSI) provider. A notification is received from the FI wallet that PII of the customer was verified by the FI to satisfy Know Your Customer (KYC) requirements imposed on the FI. Interactions and transactions between the customer operating the application and the decentralized network service are managed based on the notification.

### BRIEF DESCRIPTION OF THE DRAWINGS

FIG. 1 is a diagram of a system for PII verification for decentralized network services, according to an example embodiment.

FIG. 2 is a diagram of a method for PII verification for decentralized network services, according to an example embodiment.

FIG. 3 is a diagram of another method for PII verification for decentralized network services, according to an example embodiment.

### DETAILED DESCRIPTION

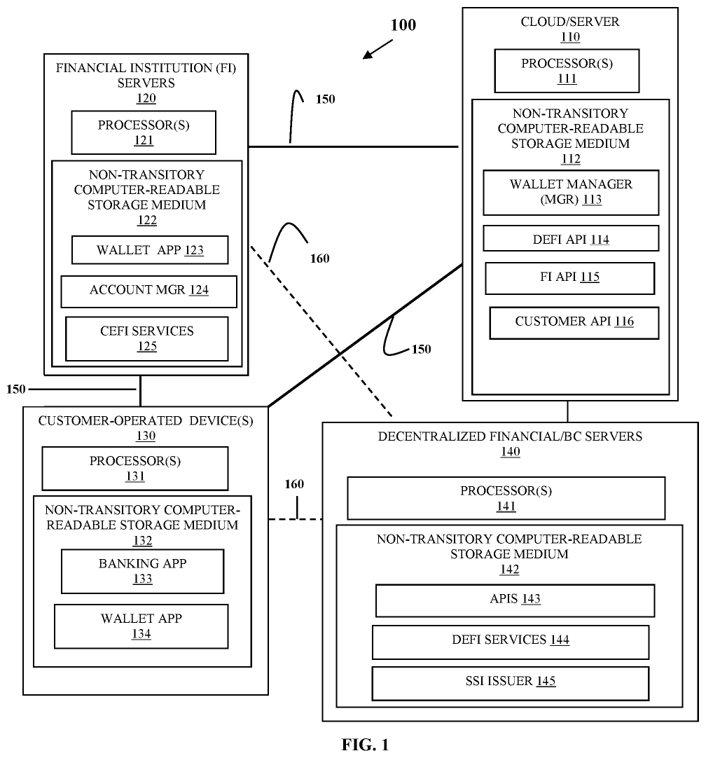

FIG. 1 is a diagram of a system 100 for PII verification for decentralized network services, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from PII verification for decentralized network services teachings presented herein and below.

Moreover, various components are implemented as one or more software modules, which reside in non-transitory storage and/or hardware memory as executable instructions that when executed by one or more hardware processors perform the processing discussed herein and below.

System 100 describes techniques by which Self-Sovereign Identity (SSI) is used in combination for a cloud-hosted service that offloads DeFi service options from FIs while integrating a customers CeFi services with the FI through the FI's banking application (app). The SSI permits cryptographic verification of a banks KYC requirements with their customers when their customers elect to use third-party cloud-hosted DeFi services. The FIs adhere to KYC requirements without the risk of holding cryptocurrencies since the cryptocurrency services are strictly held by the cloud-hosted DeFi service. At the same time, the FIs can offer DeFi cryptocurrency services to their customers through through their banking customer apps while adhering to KY requirements using SSI verifications indicating the customers willingly and knowingly elected to pursue the DeFi cryptocurrency services.

As discussed more completely herein and below, CeFi institutions do not hold nor are they exposed to the risks associated with DeFi services, but they do permit customers to move government-backed currency from accounts into DeFi wallets for purposes of investing in and/or lending the government-backed currency in their accounts via DeFi services. Moreover, crypto funds held in DeFi wallets can be freely redeemed and deposited for use in conventional CeFi services.

A cloud uses an Application Programming Interface (API) to interact with the protocols associated with other APIs of the DeFi services. The cloud pools together funds for customers of a given FI into a custodial FI wallet and maintains a ledger identifying the balances of each customer for the FI, which maps to specific accounts of the customers with the FI. Deposited funds from a given FI are purchased over the BC by the cloud as USD coins, which map directly to the value of the dollar and are held in the custodial FI wallet, such that the funds are redeemable whenever needed by the FI as government-backed currency.

Individual consumers of the bank can then use their enhanced banking app 133 to authorizing funds in a financial account with a FI to be moved to a cryptocurrency investment wallet using a wallet app associated with the banking app. The cloud creates a custodial customer wallet for the customer with the cloud, the corresponding funds from the custodial FI wallet are moved by the cloud to the customer's custodial cryptocurrency wallet and ledgers are updated to reflect the withdrawal, such that the original. The cloud actually maintains a single wallet for the FIs and their individual accounts with USD coins as custodial FI wallets to ensure the funds are non-volatile and available when requested by any given FI. Moreover, the cloud maintains a single wallet for DeFi services of customers pooled together and managed by the cloud as individual custodial cryptocurrency wallets for the customers. Ledgers maintained by the cloud ensure that the exact balances held by each FI and each customer of the FIs are up-to-date with the proper media value (USD coins and cryptocurrency coins by cryptocurrency type).

Consumers use their enhanced banking apps to move government-backed currency out of savings or checking accounts into the selected DeFi services 144. This causes the cloud to withdraw the corresponding fund amounts in USD coins from the custodial FI wallet and move the funds into the custodial cryptocurrency (DeFi) wallet with the funds identified as belonging with the customer custodial wallet. The DeFi service desired by the customer (such as lending, saving, investing, borrowing, etc.) can then be selected from the enhanced banking application using the customer's custodial wallet with the cloud. The cloud uses the pooled DeFi wallet for the customers to obtain the funds needed for the DeFi service, uses the API, and invests the funds with the DeFi service as directed by the customer and updates the ledgers and the customer's custodial wallet to reflect the investment of the funds in the DeFi service. As returns on the investment are realized or accumulate, the pooled DeFi wallet is updated, and the ledger adjustments cause the customers custodial wallet to reflect the updates. When the customer logs into their enhanced banking app, funds held with the CeFi services of the FI are shown as they normally would be, and funds held with DeFi services are also shown via a summary and detailed listing of the customer's custodial wallet provided by the cloud to the enhanced banking application.

The FI is never in any possession of any cryptocurrency, such that governmental compliance is maintained by the FI. Moreover, funds of the FI are not subject to volatility as the funds are held in USD coins are are always available for the FI to retrieve when needed. Customers of the FI can knowingly move government-backed currency from CeFi services to DeFi services the fund movements, gains, and losses are available within the enhanced banking app along with the full ledger of activity, such that volatility with the DeFi services are managed by the customers. In this way, FIs can allow their customers to get the benefit of both stable CeFi services and the potential gains associated with DeFi services through their enhanced banking app and via interaction with the cloud that provides the integration. In an embodiment, service or transaction fees for DeFi services can be collected by the cloud from the customer's custodial wallet. In an embodiment, a portion of these fees may be provided back to the FI as an enticement for the FI to integrate the cloud and its integrated CeFi and DeFi services.

However, even with the above-noted embodiments, some FIs may still be reluctant to permit integration of DeFi services with their CeFi services for their account holders (customers). This is because FIs have KYC requirements which require that the FI verify the identity of their customer with PII each time that customer is onboarded and each time a customer is offered or uses a service provided by the FI. Since, the banking app of the FI permits integration of CeFi and DeFi services, the FIs need a way to maintain and keep audit data that KYI requirements were satisfied when a given customer elects to use a DeFi service hosted by an independent cloud through the FI's banking app. The embodiments discussed herein and below solve that problem by using SSI to explicitly obtain customer consent from the proper PII in a cryptographic and secure manner. This means that FI can freely offer DeFi services through a third-party cloud without holding the risk of cryptocurrency and while remaining compliant with KYC requirements.

An SSI service permits Decentralized Identifier (DID)-based connections during an anonymous communication session between entities (users, devices, wallets, etc.) based on an addressing scheme associated with SSI; the addresses are resolved through a blockchain (BC) using BC Application Programming Interfaces (APIs). The DID connections are anonymous, encrypted, and peer-to-peer (P2P). An SSI issuing authority, or an SSI issuer may be located on standalone servers or located over the BC. A consumer/customer of a FI registers their PII with an SSI issuing authority and an encrypted wallet credential is returned to the consumer's wallet. When a customer then attempts to uses a DeFi service from a given FIs banking app, an API asks the consumer to scan a code that challenges their encrypted wallet credential. This results in DID connection between the customer and the FI where the FI requests that the customer share a portion of the PII, the customer authorized with the customer's wallet app, this results in an encrypted certification being sent to the FI along with the PII requested (as returned from the SSI issuer). The FI saves the encrypted certification as evidence that the KYC requirements were satisfied before the customer was permitted to access a selected DeFi service from the FI's banking app.

As used herein “valuable media” refers to any government-backed currencies and/or cryptocurrencies (Bitcoin®, Ethereum®, Dodgecoin®, Chainlink®, Litecoin, USD coin, etc.). A “value transfer” refers to a transfer of valuable media.

CeFi and DeFi services refer to investing, lending, or borrowing valuable media. CeFi services are offered from FIs via FI servers whereas DeFi services are offered from DeFi-based institutions via their APIs and servers.

The above discussed embodiments and other embodiments are now discussed with reference to FIGS. 1-3.

System 100 comprises a cloud/server 110, FI servers 120, customer-operated devices 130, and decentralized financial servers 140.

Cloud/Server 110 comprises at least one processor 111 and a non-transitory computer-readable storage medium 112. Medium 112 comprises executable instructions for a wallet manager 113, a DeFi Application Programming Interface (API) 114, a FI API 115, and customer API 116. When the processor 111 obtains or is provided the executable instructions from medium 112, this causes the at processor 111 to perform the operations discussed herein and below with respect to 113-116.

Each FI 120 at least one processor 121 and a non-transitory computer-readable storage medium 122. Medium 122 comprises executable instructions for a wallet application (app) 123, an account manager 124, and a variety of CeFi services 125. When the processor 121 obtains or is provided the executable instructions from medium 122, this causes the at processor 121 to perform the operations discussed herein and below with respect to 123-125.

Each customer-operated device 130 comprises at least one processor 131 and a non-transitory computer-readable storage medium 132. Medium 132 comprises executable instructions for a banking app 133 and a wallet app 134. When the processor 131 obtains or is provided the executable instructions from medium 132, this causes the at processor 131 to perform the operations discussed herein and below with respect to 133-134.

Each decentralized financial server (node) 140 comprises at least one processor 141 and a non-transitory computer readable storage medium 142. Medium 140 comprises executable instructions for APIs 143, a plurality of DeFi services 144, and one or more SSI issuers 154. When the executable instructions are provided to corresponding processor 141 from medium 142, this causes processor 141 to perform operations discussed herein and below for 143-145.

System 100 uses a layer on top of existing DeFi services and the BC through value transfers between CeFi services 125 and DeFi services 144 are achieved, managed, and integrated with a banking app 133 of a given FI. A “customer” can be an individual, a business entity, such as a retailer, a governmental entity, or a for profit or non-profit organization.

Initially, an existing banking app is enhanced as a new banking app 133 that includes processing for maintaining and interacting with a wallet app 134. The wallet app 134 interacts through an API with wallet manager 113. FI servers 120 are enhanced to include a wallet app 123 that interacts with account manager 124, and wallet app 123 interacts with wallet manager 113 through an API.

A FI is registered with for a custodial wallet via wallet app 123. Funds held in savings, checking, and/or money markets can be deposited into the custodial wallet using wallet app 123 through interaction with wallet manager 113. Wallet manager 113 credits the individual custodial wallet of each FI with the funds they transferred and purchases stable USD coins to fund a FI pooled wallet on cloud 110. Details associated with the initial funding of the custodial wallet, such as account number for the corresponding customer and balance are managed in a ledger by wallet manager 113. For example, if $100,000 is transferred by a given FI to fund the custodial wallet and $70,000 is from account A with $30,000 from account B. Wallet manager 113 maintains a single pooled wallet having 100,000 USD coins with a ledger showing 70,000 USD coins belong with account A and 30,000 USD coins below with account B. Account manager 124 may also include a ledger indicating the funds belonging to accounts A and B are held in the custodial FI wallet accessible from wallet app 123. Interaction between FI server 120 and cloud 100 occurs via FI API 115.

A customer having the newly enhanced banking app 133 logs into FI server 120 when opening app 133 through the user-facing interface of app 133. This causes customer API 116 to present user-facing interface options to the customer for investing or borrowing from available DeFi services 144 (identified and obtained by cloud 110 through DeFi API 114). The customer is also presented an option for creating a custodial wallet via wallet app 134. The customer creates a custodial wallet via interaction between the user-facing interface of app 133, wallet app 134, and wallet manager 114 using customer API 116. Once the customer custodial wallet is created for the customer, the customer may fund the custodial wallet utilizing any of the funds available from the customer's existing CeFi services 125 and their accounts for purpose of purchasing or investing in any of the DeFi services 144. In an embodiment, the customer may also use a personal digital wallet of the customer that currently has cryptocurrency valuable media and transfer any such funds to the newly created customer custodial wallet.

The customer is also asked via API 116 to register PII with an SSI issuer 145, this causes an anonymous encrypted P2P DID connection 160 between the wallet app 134 and the SSI issuer 145. The customer registered their PII with issuer 145 and is returned credential that is housed in wallet app 134. At this point, the customer is set up to begin uses DeFi services 144 through banking app 133.

When the customer is operating banking app 133 and performs a transaction that is associated with a DeFi service 144, customer API 116 causes wallet app 134 to establish a DID connection 160 between wallet app 134 and wallet app 123 of the FI server 120. The DID connection 160 allows wallet app 123 to request wallet app 134 to scan an QR code that challenges the customers PII and a request to share a portion of the customer's PII with the FI (through wallet app 123). The customer opens wallet app 134 and sees the requests from the FI wallet app 123 to share specific PII information and authorizes the sharing for purposes of being authorized to continue with the DeFi service 144 desired by the customer. The SSI issuer sees the permission or authorization to share a portion of the customer's registered PII and sends a credential with the shared portion of the PII for the customer to wallet app 123. Wallet app 123 interacts with account manager 124 to both authenticate the customer and to record the credential on an account associated with the customer. This provides a secure and provable audit trail on the customer's account records that the customer provided their identity when requesting the DeFi service from enhanced banking app 133 of the corresponding FI server 120.

Once the KYC requirements are satisfied and verification recorded, wallet app 123 sends a message to wallet manager 113, wallet manager 113 authorized API 116 to interact with the customer via the banking app 133 and the selected DeFi service 144 originally selected by the customer through banking app 133.

As illustrated in FIG. 1, DID-based connections are identified by broken lines as 160 and non-DID-based connections or direct connections are identified as 150.

When a value transfer is performed via 100 133 for purposes of funding the custodial wallet, the custodial wallet is near instantaneously funded with current existing cryptocurrency valuable media held in a pooled single customer wallet by wallet manager 113 by updating a ledger maintained with the funds indicating that the funds in the pooled customer wallet below to the customer's custodial wallet. Any actual BC operations needed to obtain the funds in the pooled customer wallet are performed or initiated and properly reflected within the pooled customer wallet once the BC operations confirm the transfer. For any initial funding of the customer custodial wallet that utilizes accounts associated with the CeFi services 125, wallet manager 113 obtains the USD coins representing the amount of funds from the pooled FI wallet, initiates and BC operations needed to sell the USD coins and buy the customer-desired cryptocurrency, flags the cryptocurrency type and amount within the pooled customer wallet, and updates the ledgers associated with the pooled FI wallet, the pooled wallet, the FI custodial wallet, and the custodial customer wallet.

At this point, the FI custodial wallet's ledger shows a withdraw by the customer for the amount from the corresponding customer account, wallet app 123 reports the ledger entry to account manager 124, and account manager updates the account of the customer with the corresponding CeFi service 125. This causes banking app 133 to refresh showing the withdrawn amount from the account of the CeFi service 125 and showing the deposited amount in the cryptocurrency type and equivalent amount for the corresponding DeFi service 144 that the customer selected or purchased using the original funds of the account for the CeFi service 125.

The DeFi service 144 selected may be the customer lending a specific amount to a borrower (institution or a specific individual) at an agreed interest rate and term of interest. In such a situation, the wallet app 134 shows the amount as a negative amount along with the terms of the loan with the account services page of app 133 to the customer.

As return is realized from the DeFi services, such as agreed interest rate, loan payments with agreed interest, asset value increases or decreases (current market value of a given cryptocurrency), this is reflected within app 133 to the customer during a session and/or when logged into app 133. Wallet manager 113 reports the valuable media amounts in the valuable media types to DeFi app 114, DeFi app 114 interacts with the corresponding APIs 143 of the corresponding DeFi services 144 obtains the return and updates wallet app 134 accordingly. In this way, the customer sees real-time results.

Even when the customer is not logged into and does not have a session with app 133, the DeFi services when receiving loan payments, making interest payments, or remoting decreased or increased values in a cryptocurrency type will automatically update the pooled customer wallet managed by wallet manager 113. These updates are properly credited or debited to the corresponding customer custodial wallet via the ledger and are immediately available through wallet app 134 and banking app 133.

System 100 presents a great number of beneficial possibilities for consumers. For example, a consumer can deposit funds for a given cryptocurrency into the custodial wallet as bitcoin and uses a given DeFi service 144 that provides a USD cash loan for the amount of the bitcoin at agreed to terms. The Defi service 144 returns USD coins to the customer custodial wallet, which the customer transfers to a checking account associated with a checking CeFi service 125 of the customers FI using app 133. The customer then write a check for purchasing a new car from the checking account. Notice that the customer has not underwent a tax even for purposes of taxes because the customer never cashed out the bitcoin it is being held as collateral by the DeFi service 144 for repayment of a loan. This is but one example of many possible with system 100.

System 100 also demonstrates that risks associated with cryptocurrency can be born by a cloud service (113-116) on behalf of a FI while customers can access and integrated funds between CeFi services 125 of their FI and DeFi services 144 available over the BC. Each time a customer attempts to utilize a given DeFi service 144 within the banking app 133, cloud customer API 116 establishes a DID-based connection between customer wallet app 134 and the FI wallet app 123. The PII of the customer is challenged and authorized by the customer, causing the needed PII to be provided by the SSI issuer 145. The certification returned back from the SSI issuer 145 and needed PII information (type of needed PII information used for customer identity verification) can be recorded in customer account records for a customer account with the FI. This satisfies KYC requirements for the FI, such that there is no violation of the KYC requirements when the FI allows a customer to access cloud-managed DeFi services 144 through the FI's banking app 133. The means that all the present barriers to FIs in allowing customers to participate in DeFi cryptocurrency-based services 144 via FIs' banking apps 133 for their customers have been removed with the teachings presented herein.

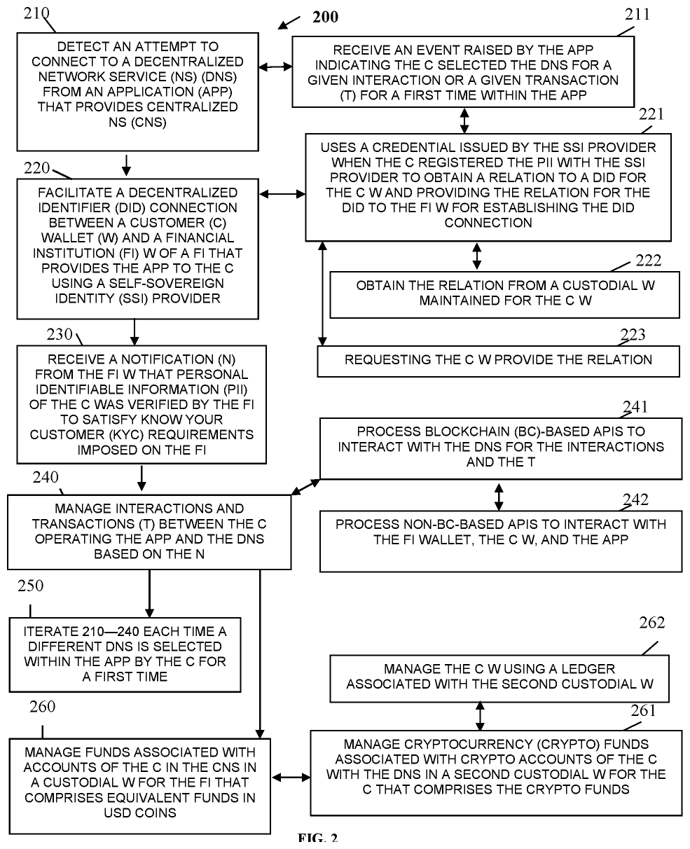

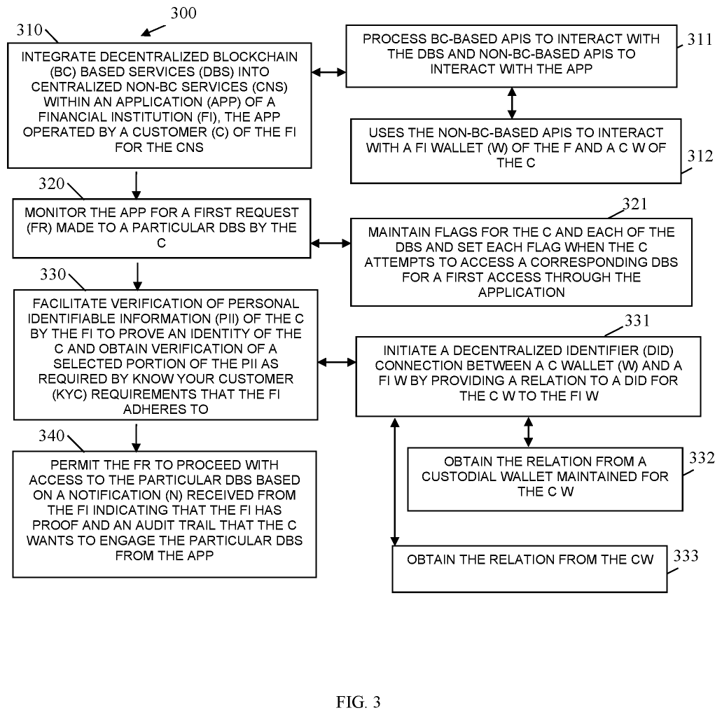

The embodiments of FIG. 1 and other embodiments are now discussed with reference to the FIGS. 2-3.

FIG. 2 is a diagram of a method 200 for PII verification for decentralized network services, according to an example embodiment. The software module(s) that implements the method 200 is referred to as a “KYC PII verifier for DeFi services.” The KYC PII verifier for DeFi services is implemented as executable instructions programmed and residing within memory and/or a non-transitory computer-readable (processor-readable) storage medium and executed by a plurality of hardware processors of a plurality of hardware computing devices. The processors of the devices that execute the KYC PII verifier for DeFi services. are specifically configured and programmed to process the KYC PII verifier for DeFi services. The KYC PII verifier for DeFi services has access to one or more networks during its processing. The networks can be wired, wireless, or a combination of wired and wireless.

In an embodiment, the devices that execute the KYC PII verifier for DeFi services is cloud 110 and/or server 110.

In an embodiment, the KYC PII verifier for DeFi services is all or some combination of 113, 114, 115, 116, 123, 133, and/or 134, discussed above with system 100.

At 210, the KYC PII verifier for DeFi services detects an attempt to connect to a decentralized network service (DeFi service 144) from an application 133 that provides centralized network services (CeFi services 125).

In an embodiment, at 211, the KYC PII verifier for DeFi services receives an event raised by the application 133 indicating the customer selected the decentralized network service 144 for a given interaction or a given transaction for a first time within the application 133.

At 220, the KYC PII verifier for DeFi services facilitates a DID connection between a customer wallet 134 of the customer and a FI wallet 123 of the FI that provides the application 133 to the customer using a SII provider 145.

In an embodiment of 211 and 220, at 221, the KYC PII verifier for DeFi services uses a credential issued by the SII provider 145 when the customer registered the PII information with the SSI provider 145 to obtain a relation to a DID for the customer wallet 134 and the KYC PII verifier for DeFi services provides the relation for the DID to the FI wallet 123 for establishing the DID connection.

In an embodiment of 221 and at 222, the KYC PII verifier for DeFi services obtains the relation from a custodial wallet maintained for the customer wallet 134.

In an embodiment of 221 and at 223, the KYC PII verifier for DeFi services requests that the customer wallet 134 provide the relation.

At 230, the KYC PII verifier for DeFi services receives a notification from the FI wallet 123 indicating that PII of the customer was verified by the FI to satisfy KYC requirements imposed on the FI.

At 240, the KYC PII verifier for DeFi services manages interactions and transactions between the customer operating the application 133 and the decentralized network service 144 based on receipt of the notification from the FI wallet 123 at 230.

In an embodiment, at 241, the KYC PII verifier for DeFi services processes BC-based APIs 114 to interact with the decentralized network service 144 for the interactions and transactions.

In an embodiment of 241 and at 242, the KYC PII verifier for DeFi services processes non-BC-based APIs 115 and 116 to interact with the FI wallet 123, the customer wallet 134, and the application 133.

In an embodiment, at 250, the KYC PII verifier for DeFi services iterates (210-240) each time a different decentralized network service 144 is selected within the application 133 by the customer for a first time.

In an embodiment, at 260, the KYC PII verifier for DeFi services manages funds associated with accounts of the customer in the centralized network services 125 in a custodial wallet for the FI that comprises equivalent funds in USD cryptocurrency coins.

In an embodiment of 260 and at 261, the KYC PII verifier for DeFi services manages cryptocurrency funds associated with cryptocurrency accounts of the customer within the decentralized network service 144 in a second custodial wallet for the customer that comprises the cryptocurrency funds.

In an embodiment of 261 and at 262, the KYC PII verifier for DeFi services manages the customer wallet 134 using a ledger associated with the second custodial wallet.

FIG. 3 is a diagram of another method 300 for PII verification for decentralized network services, according to an example embodiment. The software module(s) that implements the method 300 is referred to as a “KYC audit manager.” The KYC audit manager is implemented as executable instructions programmed and residing within memory and/or a non-transitory computer-readable (processor-readable) storage medium and executed by one or more hardware processors of one or more hardware devices. The processors of the devices that execute the KYC audit manager are specifically configured and programmed to process the KYC audit manager. The KYC audit manager has access to one or more networks during its processing. The networks can be wired, wireless, or a combination of wired and wireless.

The KYC audit manager presents another and, in some ways, enhanced processing perspective of that which was described above with the method 200.

In an embodiment, cloud 110 executes the KYC audit manager.

In an embodiment, the KYC audit manager is all or some combination of 113, 114, 115, 116, 123, 133, 134, and/or method 200.

At 310, the KYC audit manager integrates decentralized BC-based services 144 into centralized non-BC-based services 125 within an application 133 of a FI. The application 133 operated by a customer of the FI for the centralized non-BC-based services 125.

In an embodiment, at 311, the KYC audit manager processes BC-based APIs 114 to interact with the decentralized BC-based services 144 and non-BC-based APIs 115 and 116 to interact with the application 133.

In an embodiment of 311 and at 312, the KYC audit manager uses the non-BC-based APIs 115 and 116 to interact with a FI wallet 123 of the FI and a customer wallet 134 of the customer.

At 320, the KYC audit manager monitors the application 133 for a first request made to a particular decentralized NC-based service 144 by the customer.

In an embodiment, at 321, the KYC audit manager maintains flags for the customer and each of the decentralized BC-based services 144 and sets each flag when the customer attempts to access a corresponding decentralized BC-based service 144 through the application 133.

At 330, the KYC audit manager facilitates verification of PII of the customer by the FI to prove an identity of the customer and to obtain verification of a selected portion of the PII as required by KYC requirements that the FI adheres to.

In an embodiment, at 331, the KYC audit manager initiates a DID connection between a customer wallet 134 and a FI wallet 123 by providing a relation to a DID for the customer wallet 134 to the FI wallet 123.

In an embodiment of 331 and at 332, the KYC audit manager obtains the relation from a custodial wallet maintained for the customer wallet 134.

In an embodiment of 331 and at 333, the KYC audit manager obtains the relation from the customer wallet 134.

At 340, the KYC audit manager permits the first request (received at 320) to proceed with access to the particular decentralized BC-based service 144 based on a notification received from the FI indicating that the FI has proof and an audit trail that the customer wants to engage and has authorized engagement to the particular decentralized BC-based service 144 from the application 133.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
detecting an attempt to connect to a decentralized network service from an application that provides centralized network services;
facilitating a decentralized identifier (DID) connection between a customer wallet of a customer and a financial institution (FI) wallet of a FI that provides the application to the customer using a Self-Sovereign Identity (SSI) provider;
receiving a notification from the FI wallet that Personal Identifiable Information (PII) of the customer was verified by the FI to satisfy Know Your Customer (KYC) requirements imposed on the FI; and
managing interactions and transactions between the customer operating the application and the decentralized network service based on the notification.

2. The method of claim 1 further comprising, iterating the method each time a different decentralized network service is selected within the application by the customer for a first time.

3. The method of claim 1 further comprising, managing funds associated with accounts of the customer in the centralized network services in a custodial wallet for the FI that comprises equivalent funds in United States Dollar (USD) coins.

4. The method of claim 3, wherein managing the funds further includes managing cryptocurrency funds associated with cryptocurrency accounts of the customer with the decentralized network service in a second custodial wallet for the customer that comprises the cryptocurrency funds.

5. The method of claim 4, wherein managing the cryptocurrency funds further includes managing the customer wallet using a ledger associated with the second custodial wallet.

6. The method of claim 1, wherein detecting further includes receiving an event raised by the application indicating that the customer selected the decentralized network service for a given interaction or a given transaction for a first item within the application.

7. The method of claim 6, wherein facilitating further includes using a credential issued by the SII provider when the customer registered the PII with the SII provider to obtain a relation to a DID for the customer wallet and providing the relation for the DID to the FI wallet for establishing the DID connection.

8. The method of claim 7, wherein using further includes obtaining the relation from a custodial wallet maintained for the customer wallet.

9. The method of claim 7, using further includes requesting the customer wallet provide the relation.

10. The method of claim 1, managing further includes processing Blockchain (BC)-based Application Programming Interfaces (APIs) to interact with the decentralized service for the interactions and the transactions.

11. The method of claim 10, wherein processing further includes processing non-BC-based APIs to interact with the FI wallet, the customer wallet, and the application.

12. A method, comprising:
integrating decentralized blockchain (BC)-based services into centralized non-BC services within an application of a Financial Institution (FI), wherein the application operated by a customer of the FI for the centralized non-BC services;
monitoring the application for first request made to a particular decentralized BC-based service by the customer;
facilitating verification of Personal Identifiable Information (PII) of the customer by the FI to prove an identity of the customer and obtain verification of a selected portion of the PII by the FI as required by Know Your Customer (KYC) requirements that the FI adheres to; and
permitting the first request to proceed with access to the particular decentralized BC-based service based on a notification received from the FI indicating that the FI has proof and an audit trail that the customer wants to engage the particular decentralized BC-based service from the application.

13. The method of claim 12, wherein integrating further includes processing BC-based Application Programming Interfaces (APIs) to interact with the decentralized BC-based services and non-BC-based APIs to interact with the application.

14. The method of claim 13, wherein processing further includes using the non-BC-based APIs to interact with a FI wallet of the FI and a customer wallet of the customer.

15. The method of claim 12, wherein monitoring further includes maintaining flags for the customer and each of the decentralized BC-based services and set each flag when the customer attempts to access a corresponding decentralized BC-based service for a first access through the application.

16. The method of claim 12, wherein facilitating further include initiating a Decentralized Identifier (DID) connection between a customer wallet and a FI wallet by providing a relation for a DID of the customer wallet to the FI wallet.

17. The method of claim 16, wherein initiating further includes obtaining the relation from a custodial wallet maintained for the customer wallet.

18. The method of claim 16, wherein initiating further includes obtaining the relation from the customer wallet.

19. A system comprising:
a cloud comprising a plurality of servers;
each server comprising at least one processor and a non-transitory computer-readable storage medium;
each non-transitory computer-readable storage medium comprising executable instructions;
the executable instructions when provided to or obtained by the corresponding processor from the corresponding non-transitory computer-readable storage medium cause the corresponding processor to perform operations, comprising:
integrating decentralized network services into an application associated with centralized network services, wherein the centralized network services and the application associated with a Financial Institution (FI);
each time a customer who operates the application attempts to access a given decentralized network service for a first time:
obtaining a relation to a Decentralized Identifier (DID) associated with a customer wallet of the customer;
passing the relation to a FI wallet of the FI for the FI wallet to establish a DID connection to the customer wallet using a Self-Sovereign Identity (SSI) provider that pre-registered Personal Identifiable Information (PII) of the customer and provided the customer wallet a credential;
receiving a notification from the FI wallet that a customer identity for the customer and a portion of the PII was verified through the SSI provider and the customer during the DID connection, the FI retaining a verification in account records associated with the customer to satisfy Know Your Customer (KYC) requirements adhered to by the FI; and
permitting the customer to access the given decentralized network service for a transaction through the application.

20. The system of claim 19, wherein each time the customer who operates the application attempts to access the given decentralized network service for a first time further includes:
setting a flag on a customer identifier for the customer and a service identifier for the given decentralized network service ensuring that the KYC requirements needed by the FI for the given decentralized network service do not require processing a second time that the customer attempts to access the given decentralized network service.
